(19) United States
(12) Patent Application Publication
(10) Pub. No.: US 2019/0302249 A1
(43) Pub. Date: Oct. 3, 2019

(54) SYSTEM AND METHOD FOR DRONE POSITION DETERMINATION

(71) Applicant: Walmart Apollo, LLC, Bentonville, AR (US)

(72) Inventors: Donald R. High, Noel, MO (US); David C. Winkle, Bella Vista, AR (US); John J. O'Brien, Farmington, AR (US); Robert L. Cantrell, Herndon, VA (US); Todd D. Mattingly, Bentonville, AR (US); Brian G. McHale, Chadderton Oldham (GB)

(21) Appl. No.: 16/357,534

(22) Filed: Mar. 19, 2019

Related U.S. Application Data
(60) Provisional application No. 62/649,690, filed on Mar. 29, 2018.

(51) Int. Cl. G01S 11/12; G01S 7/48; B64C 39/02

(52) U.S. Cl. CPC G01S 11/12; B64C 2201/146; B64C 39/024; G01S 7/4804

(57) ABSTRACT

Electromagnetic energy signals are transmitted to an aerial drone. A comparison of the identification information inherent to these signals is made with acceptable identification information in a ledger stored at the drone. When the comparison identifies a valid transmission station, the control circuit allows the processing of the electromagnetic energy signals from the valid transmission station. The processing is effective to ascertain the location of or fine-tune the location of the aerial drone.

### CROSS-REFERENCE TO RELATED APPLICATION

This application claims the benefit of the following U.S. Provisional Application No. 62/649,690 filed Mar. 29, 2018, which is incorporated herein by reference in its entirety.

### TECHNICAL FIELD

These teachings relate to operating aerial drones and, more specifically, to determining the current location of a drone based upon trusted sources.

### BACKGROUND

Aerial drones are used for various tasks. In one example, aerial drones are used to deliver packages to the homes of customers, warehouses, distribution centers, or retail stores. In other examples, drones can be used to perform non-delivery tasks such as surveillance or monitoring.

In order for a drone to operate properly, the aerial drone typically needs to know its current location and this location needs to be accurate. If the current location is not accurate, then various adverse consequences can occur. For example, when a drone is operating along or in a delivery route, and the location it is using for navigational purposes is inaccurate, the drone may make maneuvers that are improper leading to accidents. For instance, the drone may collide with buildings, trees, people, or other obstacles. This may, in turn, result in severe damage to the drone and/or the package, causing delivery of the package to be delayed or interrupted.

### BRIEF DESCRIPTION OF THE DRAWINGS

The above needs are at least partially met through the provision of approaches that determine the location of a drone using trusted electromagnetic energy transmission sources (e.g., light transmitting sources), wherein:

FIG. 1 comprises a diagram of a system as configured in accordance with various embodiments of these teachings;

FIG. 2 comprises a flowchart as configured in accordance with various embodiments of these teachings;

FIG. 3 comprises a diagram of a system as configured in accordance with various embodiments of these teachings;

FIG. 4 comprises an illustration of blocks as configured in accordance with various embodiments of these teachings;

FIG. 5 comprises an illustration of transactions configured in accordance with various embodiments of these teachings;

FIG. 6 comprises a flow diagram in accordance with various embodiments of these teachings;

FIG. 7 comprises a process diagram as configured in accordance with various embodiments of these teachings;

FIG. 8 comprises an illustration of a delivery record configured in accordance with various embodiments of these teachings;

FIG. 9 comprises a system diagram configured in accordance with various embodiments of these teachings.

### DETAILED DESCRIPTION

Generally speaking, transmission stations transmit electromagnetic energy signals (e.g., visible light signals) that are received by aerial drones. The signals carry information (e.g., embedded information or are pulsed with the information). The information identifies the sending station (e.g., the information may be some combination of identifiers, passwords, security keys, or the location of the sending station). The drone stores a ledger of acceptable identification information of valid transmitting stations. The drone compares the received information with the information on the ledger, and when there is agreement, uses the electromagnetic energy signals to ascertain the location of the drone or fine-tune the location of the drone.

In many of these embodiments, a system is configured to allow an aerial drone to autonomously determine its current location using received electromagnetic energy signals. The system includes a plurality of transmission stations and an aerial drone. The aerial drone includes a transceiver circuit, a control circuit, and a memory device.

Each of the transmission stations is configured to transmit electromagnetic energy signals. Each of the electromagnetic energy signals communicates data.

The transceiver circuit of the aerial drone is configured to receive at least some of the electromagnetic energy signals from the transmitting stations. The memory device of the aerial drone is configured to store a ledger of acceptable identification information. In aspects, the ledger is a block chain that stores transactions.

The control circuit of the aerial drone is configured to perform a comparison of identification information associated with the electromagnetic energy signals to the acceptable identification information in the ledger. When the comparison identifies a valid transmission station, the control circuit is configured to allow the processing of the electromagnetic energy signals from the valid transmission station. The processing is effective to ascertain the location of, or fine-tune the location of, the aerial drone. The aerial drone is subsequently operated according to the modified location by the control circuit. When the comparison identifies an invalid transmission station, the control circuit is configured to ignore signals transmitted from the invalid transmission station.

In other examples, the electromagnetic energy signals are visible light signals. In examples, the data is embedded or encoded into the electromagnetic energy signals. In other aspects, the electromagnetic energy signals are pulsed according to varied wavelengths to convey the data.

In still other examples, the acceptable identification information includes acceptable keys, geographic coordinates, codes, identifiers, store numbers, or patterns. Other examples are possible.

In other aspects, the location is ascertained through triangulation or landmark recognition approaches. Other examples are possible.

In still other examples, the aerial drone communicates with the transmission stations using second electromagnetic energy signals. The second electromagnetic energy signals may be visible light signals, to mention one example.

In some examples, the transmission station is at a fixed location on the ground or is a mobile electronics device. In still other examples, the transmission station is a second aerial drone.

In others of these embodiments, electromagnetic energy signals are transmitted from a plurality of transmission stations. Each of the signals communicates data. The signals are received at an aerial drone. The aerial drone includes a transceiver circuit, a control circuit, and a memory device. The transceiver circuit is configured to receive at least some of the signals.

A ledger of acceptable identification information is stored in the memory device at the aerial drone. In aspects, the ledger is a block chain that stores transactions.

At the control circuit of each aerial drone, a comparison of identification information inherent to or transmitted is performed with the electromagnetic energy signals to the acceptable identification information in the ledger. When the comparison identifies a valid transmission station, the control circuit allows the processing of the electromagnetic energy signals from the valid transmission station. The processing is effective to ascertain the location of or fine-tune the location of the aerial drone.

At the control circuit and when the comparison identifies an invalid transmission station, the signals transmitted from the invalid transmission station are ignored. The aerial drone is operated according to the modified location.

In aspects, each individual transmission (e.g., light signal) can transmit separate air traffic control instructions from its perspective to more than one individual drone (e.g., concurrent communication). In still other aspects, information can be embedded in a block chain ledger to authenticate embedded data such as identification (ID) or store number.

In other examples, mobile applications can be used to leverage light emitting diodes (LEDs) deployed with cellular phones and enable drones to make deliveries to individuals. In these regards, the approaches described herein assist with deliveries made to remote locations where there are, for example, no dedicated landing or delivery facilities. These approaches are also effective in allowing a drone to distinguish individuals more precisely in a crowd of numerous individuals. More specifically, personal identification information can be transmitted using the LEDs deployed with the phone. In other words, a person (and their smart phone) becomes the transmission or ground station. Additionally, three phones in the same area provide sufficient LED triangulation to determine an accurate current location for the drone, for example, allowing the drone to establish a landing area in an unlighted parking area.

In still other examples, each ground station has an LED light attached, and this LED light is directed to shine vertically upward. In aspects, the LED light is identified by the particular frequencies that are associated with the ground station. This LED light information is used by the drone to identify the ground station. In examples, the drone could look-up the location of the station using the central computer database of ground stations.

It will be appreciated that the system could use modulated signals to enable the identifying of triangulating signals. Further, the transmission stations could also add meta-data to the transmissions (which could be beacon transmissions).

In yet other examples, the system could employ trucks, distribution centers, retail stores and other fixed location sources (local ground stations) which would transmit their location using a low power transmitter so that drones in the vicinity could determine their general location. Each ground station could have an LED light (or other electromagnetic energy source), which is directed to shine vertically upward. The LED light (or other electromagnetic energy source) would be identified by the particular frequencies of the ground station.

Additionally, and in other aspects, images of recognizable landmarks are analyzed by the system to determine the location of the drone. The system could also use beacon data from one or two ground stations along with image data from a drone to determine the location of the drone (landmark recognition). In still other examples, the system uses hybrid triangulation plus imaging, pre-processing triangulation signals to narrow the selection of what images to process. This information may be used as a sanity check for the drone's location or it may be used as a homing signal for the drone to follow to return to a home or base location.

In still other examples, the system is able to triangulate using multiple LED light sources (or any other electromagnetic energy sources). Each LED light (or other electromagnetic energy source) in a geographic area is assigned an identifier, which the system uses to determine the location of a drone. These LED lights (or other electromagnetic energy sources) can be mounted on light poles facing up for flying drones and also facing down for ground vehicles. In other examples, the LEDs (or other electromagnetic energy sources) can be mounted on houses or other buildings for more precise targeting.

In aspects, a customer activates the LED lights (or other electromagnetic energy source) and deploys their landing pad when expecting a delivery. The present approaches allow electromagnetic energy sources (e.g., visible lights) to communicate with the drone digitally (similar to WIFI). In one example, Hue lights (manufactured by Phillips Light Company) could be used outside a customer's home to signal to the drone when the customer is waiting for a delivery. Further, the system communicates with the customer's home light controller hub to choose a particular color (frequency) of light. The system could cycle among a set of colors as well. The duration of each color could vary as the drone approaches the landing zone.

In still other aspects, the system assigns public keys to LEDs (or other electromagnetic energy sources) and these keys could be broadcast by the LEDs (or other electromagnetic energy source). In examples, a distributed ledger provides geographic coordinates for each light (or other electromagnetic energy) source. Such approaches allow for an open system of LED lights (or other electromagnetic energy sources) and locations to be used by multiple parties.

In yet other example, an LED source (or other electromagnetic energy source) transmits a pulse pattern. The pulse pattern emitted from an LED (or other electromagnetic energy sources) provides X, Y, Z coordinates as well as the LEDs unique public key, which can be referenced on the distributed ledger for information. Further, weather information can be included within the LEDs pulse pattern.

The vehicle can assume, verify, or determine its position from a LED pulsing light (or other electromagnetic energy source) by receiving and affirming the LEDs position (which can be referenced either on the ledger or can be referenced from the pulse itself). Further, the strength of the pulse received by the unmanned autonomous vehicle (UAV) can identify the vehicle's position relative to the LED (or other electromagnetic energy source).

In other aspects, Li-Fi technologies can be used to implement light (or other electromagnetic energy) transmissions. In other examples, a LED beaconing system or electromagnetic energy source communicates identifiers that may reference a public key which can be searched and validated on a distributed ledger. LEDs (or other electromagnetic energy sources) can also distribute power to vehicles, for example, using Li-Fi technology. LEDs can also distribute sounds for distress signals, or for other purposes.

The present approaches can use fixed and permanent sources on the ground, but could also be used for other mobile systems, such as aerial drones, to communicate navigational coordinates, identifiers, and transmit data or communications. In examples, the LED (or other electromagnetic energy source) transmitted from a drone contains a root strand of the drone's identifier, which is much like a tail number; ex=N2567. The remaining strand would contain the drone's coordinates, such as X, Y, Z. Therefore, a completed identifier+location strand would resemble N25675466200, where N2567 is the tail #, and 5466 is the LAT LONG, and 200 is the altitude, in one example. In addition, pulsing identifiers could be utilized for when the vehicle is in distress, the heading of the vehicle, the mission profile (e.g., package delivery, or surveillance), authority information (e.g., police, or border control), or type of payload, to mention a few examples.

All of the identification (or other types of) information could be communicated through the pulse-pattern from the flashing light, could be referenced after receiving a pulse pattern and referencing the distributed ledger, or could be transmitted through the communications capable of Li-Fi technology. Other examples are possible.

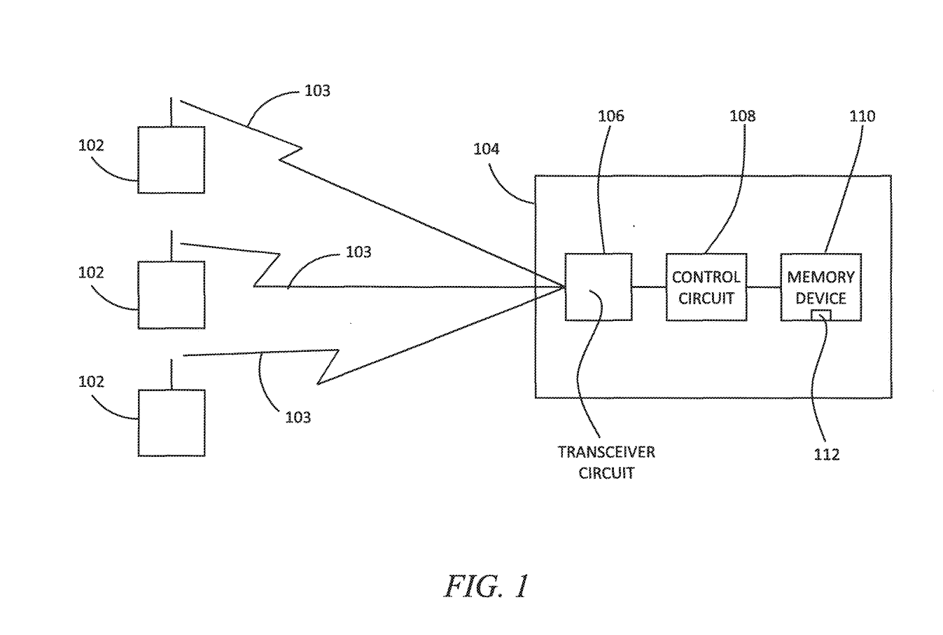

Referring now to FIG. 1, a system is configured to allow an aerial drone to autonomously determine its current location using received electromagnetic energy signals. The system includes a plurality of transmission stations 102 and an aerial drone 104. The aerial drone 104 includes a transceiver circuit 106, a control circuit 108, and a memory device 110.

Each of the transmission stations 102 is configured to transmit electromagnetic energy signals 103. Each of the electromagnetic energy signals 103 communicates data. The transmission stations 102 may transmit the electromagnetic energy signals 103 according to, or using any type of, electromagnetic energy. For example, the transmission stations 102 may transmit light in the visible spectrum. Some transmission stations 102 may transmit some types of energy (e.g. visible light of one color), while others of the transmission stations transmit other types of energy (visible light of another color).

The transmission stations 102 also encode their respective electromagnetic energy signals 103 with an identifier that identifies the particular transmission station. In examples, the electromagnetic energy signals 103 may be pulsed in a certain way to identify a particular one of the transmission stations 102. In another example, the information is embedded into the electromagnetic energy signal 103 according to techniques that are well know to those skilled in the art.

In these regards, the transmission stations 102 may be equipped with appropriate electronic hardware and/or computer software to create the transmissions including the embedding or attachment of identification information. For example, the transmission stations 102 may include light emitting diodes (LEDs) that are actuated by a controller or control circuit to create the electromagnetic energy signals 103 according to a particular frequency, pulsed in a certain pattern, or are embedded with identification information.

The transmission stations 102 can be deployed to or incorporated with any stationary or fixed device. For example, the transmission stations 102 may be ground stations, be disposed at/incorporated with other aerial drones, may be incorporated on a moving ground vehicle (e.g., an automated ground vehicle), or may be incorporated at a mobile electronic device (e.g., a smartphone).

In aspects, the aerial drone 104 includes a propulsion system and a storage bay (e.g., for storing packages that are for delivery). The propulsion system may include engines, propellers, fuel systems, batteries, and/or control devices that are effective to power and propel the drone 104. The operation of the propulsion system may be controlled by the control circuit 108.

The transceiver circuit 106 of the aerial drone 104 is configured to receive at least some of the electromagnetic energy signals from the transmission stations 102. The transceiver circuit 106 may be any combination of electronic hardware and computer software. The memory device 110 is any type of electronic computer memory device and is configured to store a ledger 112 of acceptable identification information. In aspects, the ledger 112 is or includes a block chain that stores transactions and/or acceptable identifiers.

It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 108 may be configured (for example, by using corresponding programming stored in a memory as will be well understood by those skilled in the art) to carry out one or more of the steps, actions, and/or functions described herein.

The control circuit 108 of the aerial drone 104 is configured to perform a comparison of identification information associated with the electromagnetic energy signals 103 to the acceptable identification information in the ledger 112. When the comparison identifies a valid one of the transmission stations 102, the control circuit 108 is configured to allow the processing of the electromagnetic energy signals 103 from the valid transmission station. The processing is effective to ascertain the location of, or fine-tune the location of, the aerial drone 104. The location of the aerial drone 104 is used by the control circuit 108 to navigate the aerial drone 104. When the comparison identifies an invalid one of the transmission stations 102, the control circuit 108 is configured to ignore signals transmitted from the invalid one of the transmission stations 102.

In other examples, the electromagnetic energy signals are visible light signals. In yet other examples, the data is embedded or encoded into the electromagnetic energy signals. In other aspects, the electromagnetic energy signals are pulsed according to varied wavelengths to convey the data.

In still other examples, the acceptable identification information includes acceptable keys, geographic coordinates, codes, identifiers, store number, or patterns.

In other aspects, the location of the aerial drone 104 is ascertained or verified through triangulation or landmark recognition approaches once an adequate number of transmission stations 102 have been verified as being authentic. Other examples of location determination approaches are possible. To take one example, when three transmission stations 102 (and their corresponding electromagnetic energy signals 103) have been authenticated, then these signals can be used to triangulate and determine the position of the aerial drone 104 by the control circuit 108. Such triangulation approaches are well-known in the art and will not be described further herein. In another example, the drone 104 and/or the transmission stations 102 may be equipped with cameras, and once the stations have been authenticated, then landmark recognition approaches can be used to verify the location of the drone 104. For instance, the camera images may show expected or unexpected landmarks relative to the drone, and this information may be used to determine the location of the drone 104.

In still other examples, the aerial drone 104 communicates with the transmission stations 102 using second electromagnetic energy signals. The second electromagnetic energy signals may be visible light signals, to mention one example. The messages may include various types of information (e.g., communications with or messages of interest to a user at the ground station, for example instructing the user to perform an action such as opening their door or informing the user of the impending arrival of the drone 104).

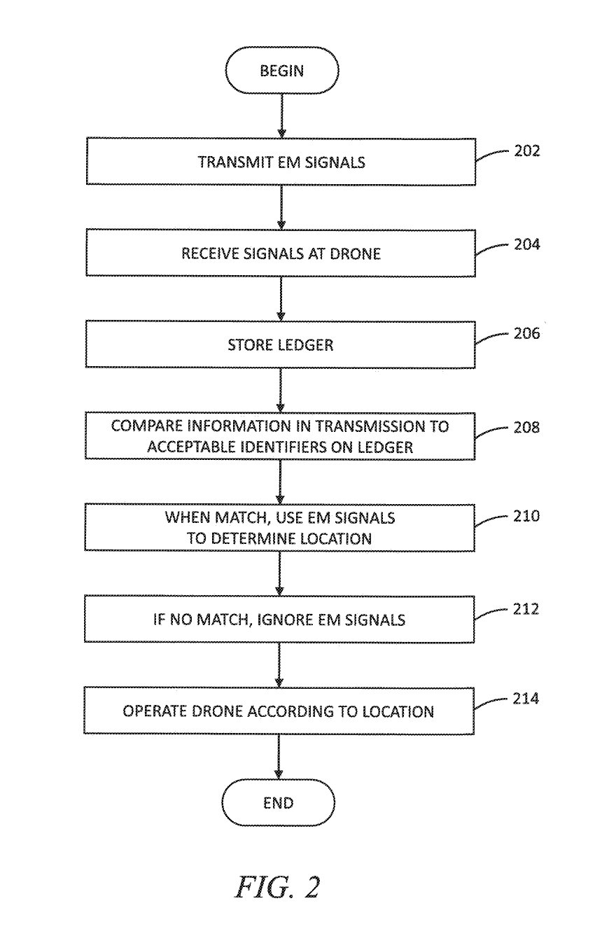

Referring now to FIG. 2, an approach for determining the location of a drone using electromagnetic energy (e.g., light) sources is described.

At step 202, electromagnetic energy signals (e.g., visible light signals) are transmitted from a plurality of transmission stations. Each of the signals communicates data. The data may be communicated by pulsing the signals, by transmitting at different frequencies, or by embedding (coding) information into the transmissions to mention a few examples.

At step 204, the signals are received at an aerial drone. The aerial drone includes a transceiver circuit, a control circuit, and a memory device. The transceiver circuit is configured to receive at least some of the signals.

At step 206, a ledger of acceptable identification information is stored in the memory device at the aerial drone. The ledger may be part of a blockchain and store acceptable identification information.

At step 208 and at the control circuit of each aerial drone, a comparison of identification information inherent to or transmitted is performed with the electromagnetic energy signals to the acceptable identification information in the ledger. For example, an identifier is extracted from the transmissions and compared to acceptable (authorized) identifiers on the ledger.

At step 210 and when the comparison identifies a valid transmission station, the control circuit allows the processing of the electromagnetic energy signals from the valid transmission station. The processing is effective to ascertain the location of or fine-tune the location of the aerial drone.

At step 212, at the control circuit and when the comparison identifies an invalid transmission station, the signals transmitted from the invalid transmission station are ignored. Other actions may also be taken. For example, the drone may perform a test on its electronic circuitry to ensure that it did not incorrectly process or receive the received transmissions.

At step 214, the aerial drone is operated according to the modified location. For example, the control circuit adjusts the altitude, velocity, path, or bearing of the drone to take into account the location.

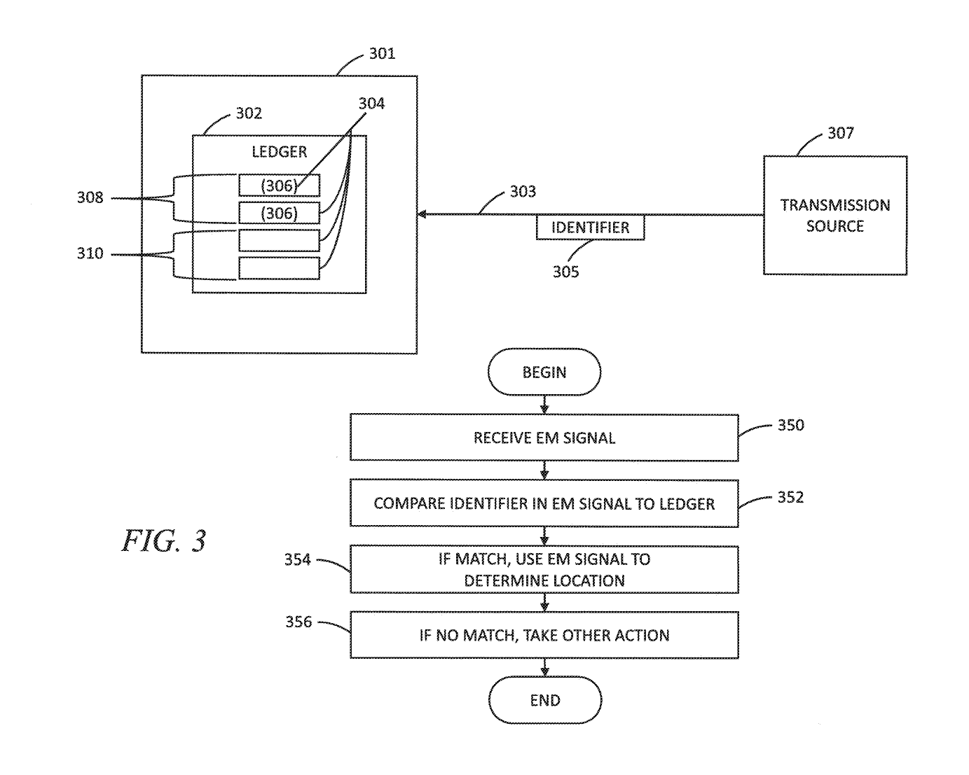

Referring now to FIG. 3, one example of an approach for verifying the identity of an electromagnetic energy transmission source at an aerial drone 301 is described. A ledger 302 includes entries 304 that identify a transmission source. The ledger 302 may be part of a block chain and record transactions as the transactions occur. When the ledger is updated, it may be shared with other aerial drones. The sharing may be accomplished, in one example, by uploading the ledger to a central processing center, another node, or some other destination, which will share the updated ledger with other drones. In other examples, the drone 301 may directly share its updates with other drones. Similarly, the central processing center, node, or other source may share ledgers (that have been updated by other drones) with the drone 301. These updated ledgers may be block chain structures that include transactional information. In this way, all aerial drones are ensured of having the most up-to-date ledger.

At step 350, an electromagnetic energy signal 303 is received from an electromagnetic energy transmission source 307. The signal 303, may in examples, be a visible light signal, an RF energy signal, or any signal in the electromagnetic energy spectrum. The signal 303 includes data. In examples, the signal is pulsed, or can have data embedded in the signal. The data may include an identifier 305. The identifier 305 may be a key, a location, geographic coordinates, a code, or any other piece of information from the transmission source 307. The identifier 305 relates to an identifier or other identification information concerning the transmission source (e.g., a ground station, other aerial drone, or cellular phone to mention a few examples).

The ledger 302 includes acceptable entries 306, which may be keys, locations, geographic coordinates, or codes to mention a few examples. The entries 306 may be organized into groups, for example, based on geographic locations. For example, a first group of entries 308 may be entries relating to transmission sources in a first US state or geographic location, and a second group of entries 310 may be entries relating to transmission sources residing in a second US state or geographic location. The groupings may change. For example, if the transmission source is mobile (e.g., a cellular phone or other aerial drone), then the entries may dynamically change groups as the ledger 302 is updated. More specifically, movement of the transmission source 307 may cause the updating of the ledger 302, and the updated ledger 302 may be shared among (downloaded to) all aerial drones.

The acceptable entries 306 stored at the ledger 302 have been determined to be acceptable. That is, the entries 306 are related to known, valid, and/or verified transmission sources. In aspects, the validity relates to whether the source is known or verified to be genuine (e.g., it is a source that is known not to be malicious), or that the source is at a particular known location (e.g., the identifier relates to a source verified to be operating in a predetermined geographic location or area) to mention two examples.

At step 352, a comparison is made between the received identifier and the ledger 302. If the ledger 302 is simply a list of acceptable sources, then the entire list may be consulted to see if the identifier is on the list. If the ledger 302 is organized by categories, the comparison checks the ledgers according to the categories. For example, if the ledger 302 has organized the list of entries by geographic areas, it is first determined the geographic area the drone 301 is operating, and then a check is made on the ledger 302 for entries that are within the geographic area. To take one specific example, the ledger 302 may group entries by US state. If the drone 301 is operating in Illinois (e.g., it may check its current coordinates to see if these coordinates correspond to an Illinois location), then a check is made of the list for entries that are verified to be in Illinois.

At step 354, if a match is determined, the drone 301 may use the signals from the source 307 to determine its location. If part of a block chain, the transaction may be added to the ledger 302.

At step 356, if no match is determined, other actions may be taken. For example, the drone 301 may test its own transmission/reception circuitry to see if it is possible that an error is present at the drone 301 that prevented the correct identifier from being recognized. In another example, the drone 301 may report non-matches to a central control center. Other examples of actions are possible.

It will be appreciated that the steps described with respect to FIG. 3 are made to verify all transmission sources used by the drone 301 to determine its location. For example, if three transmission sources are to be used, each transmission source is verified according to these approaches.

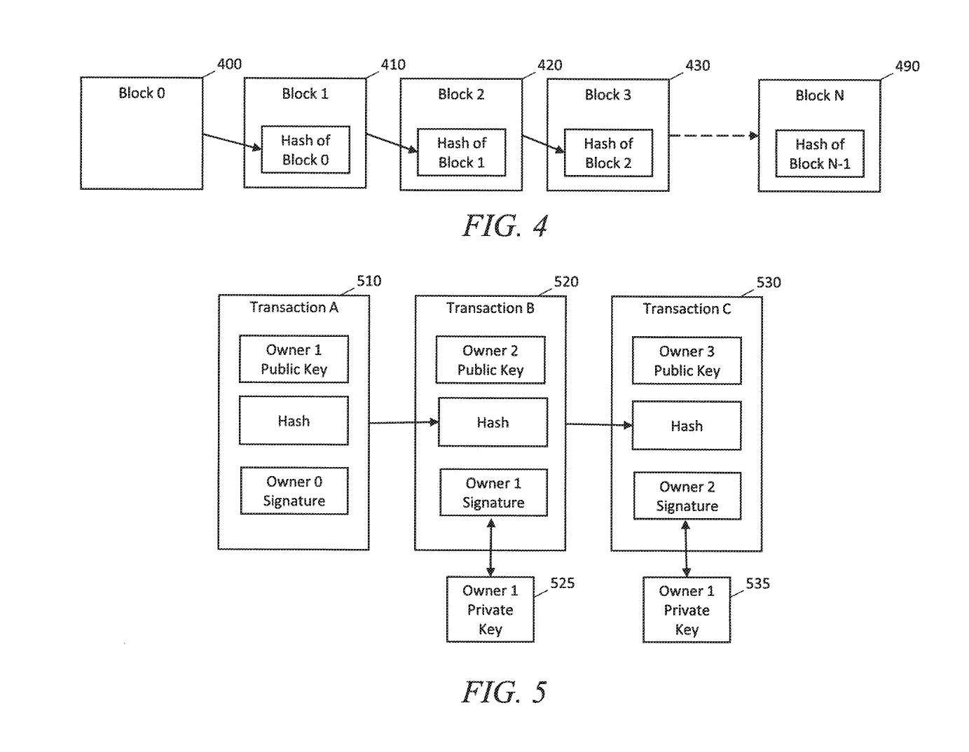

Descriptions of some embodiments of blockchain technology are provided with reference to FIG. 4-9 herein. In some embodiments of the invention described above, blockchain technology may be utilized to record valid identifiers of transmission stations. One or more of the drones described herein may comprise a node in a distributed blockchain system storing a copy of the blockchain record. Updates to the blockchain may comprise transfer of new items or updated ledgers (e.g., from a centralized processing station or facility) and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin. pdf), the entirety of which is incorporated herein by reference.

Now referring to FIG. 4, an illustration of a blockchain according to some embodiments is shown. In some embodiments, a blockchain comprises a hash chain or a hash tree in which each block added in the chain contains a hash of the previous block. In FIG. 4, block 0 400 represents a genesis block of the chain. Block 1 410 contains a hash of block 0 400, block 2 420 contains a hash of block 1 410, block 3 430 contains a hash of block 2 420, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners’ are nodes that compete to provide proof-of-work to form a new block, and the first successful miner of a new block earns Bitcoin currency in return.

Now referring to FIG. 5, an illustration of blockchain based transactions according to some embodiments is shown. In some embodiments, the blockchain illustrated in FIG. 5 comprises a hash chain protected by private/public key encryption. Transaction A 510 represents a transaction recorded in a block of a blockchain showing that owner 1 (recipient) obtained an asset from owner 0 (sender). Transaction A 510 contains owner's 1 public key and owner 0's signature for the transaction and a hash of a previous block. When owner 1 transfers the asset to owner 2, a block containing transaction B 520 is formed. The record of transaction B 520 comprises the public key of owner 2 (recipient), a hash of the previous block, and owner 1's signature for the transaction that is signed with the owner 1's private key 525 and verified using owner 1's public key in transaction A 510. When owner 2 transfers the asset to owner 3, a block containing transaction C 530 is formed. The record of transaction C 530 comprises the public key of owner 3 (recipient), a hash of the previous block, and owner 2's signature for the transaction that is signed by owner 2's private key 535 and verified using owner 2's public key from transaction B 220. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 5 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

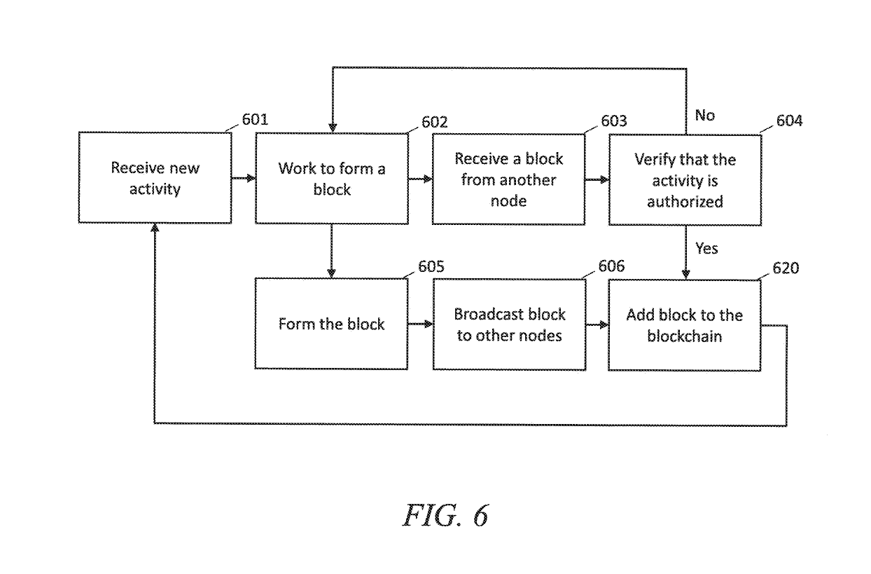

Now referring to FIG. 6, a flow diagram according to some embodiments is shown. In some embodiments, the steps shown in FIG. 6 may be performed by a processor-based device, such as a computer system, a server, a distributed server, a timestamp server, a blockchain node, and the like. In some embodiments, the steps in FIG. 6 may be performed by one or more of the nodes in a system using blockchain for record keeping.

In step 601, a node receives a new activity. The new activity may comprise an update to the record being kept in the form of a blockchain. In some embodiments, for blockchain supported digital or physical asset record keeping, the new activity may comprise a asset transaction. In some embodiments, the new activity may be broadcasted to a plurality of nodes on the network prior to step 601. In step 602, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 602, if the node successfully forms a block in step 605 prior to receiving a block from another node, the node broadcasts the block to other nodes over the network in step 606. In some embodiments, in a system with incentive features, the first node to form a block may be permitted to add incentive payment to itself in the newly formed block. In step 620, the node then adds the block to its copy of the blockchain. In the event that the node receives a block formed by another node in step 603 prior to being able to form the block, the node works to verify that the activity recorded in the received block is authorized in step 604. In some embodiments, the node may further check the new block against system consensus rules for blocks and activities to verify whether the block is properly formed. If the new block is not authorized, the node may reject the block update and return to step 602 to continue to work to form the block. If the new block is verified by the node, the node may express its approval by adding the received block to its copy of the blockchain in step 620. After a block is added, the node then returns to step 601 to form the next block using the newly extended blockchain for the hash in the new block.

In some embodiments, in the event one or more blocks having the same block number is received after step 620, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 601.

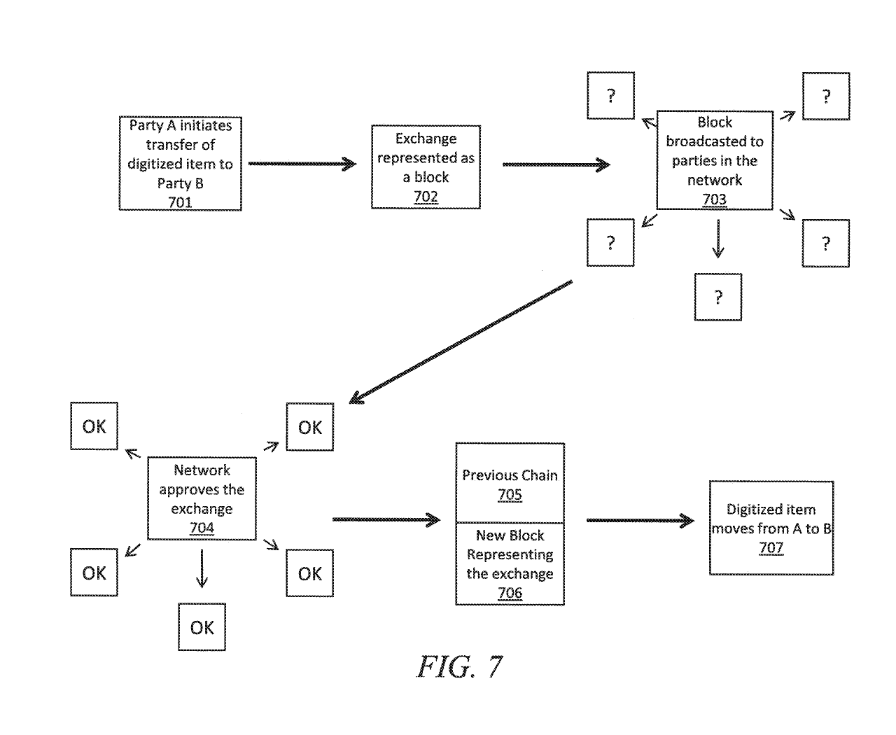

Now referring to FIG. 7, a process diagram of a blockchain update according to some implementations in shown. In step 701, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 702, the exchange initiated in step 701 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 703, the block is broadcasted to parties in the network. In step 704, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 706 representing the exchange is added to the existing chain 705 comprising blocks that chronologically precede the new block 706. The new block 706 may contain the transaction(s) and a hash of one or more blocks in the existing chain 705. In some embodiments, each node may then update their copy of the blockchain with the new block and continue to work on extending the chain with additional transactions. In step 707, when the chain is updated with the new block, the digitized item is moved from party A to party B.

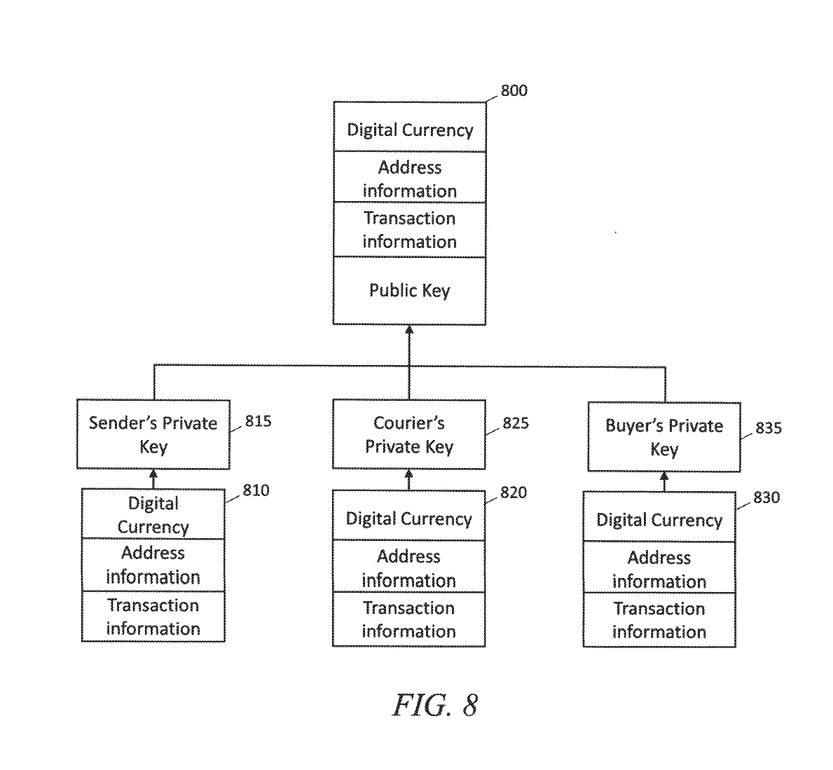

Now referring to FIG. 8, a diagram of a blockchain according to some embodiments in shown. FIG. 8 comprises an example of an implementation of a blockchain system for delivery service record keeping. The delivery record 800 comprises digital currency information, address information, transaction information, and a public key associated with one or more of a sender, a courier, and a buyer. In some embodiments, nodes associated the sender, the courier, and the buyer may each store a copy of the delivery record 810, 820, and 830 respectively. In some embodiments, the delivery record 800 comprises a public key that allows the sender, the courier, and/or the buyer to view and/or update the delivery record 800 using their private keys 815, 825, and the 835 respectively. For example, when a package is transferred from a sender to the courier, the sender may use the sender's private key 815 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 825 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 8, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

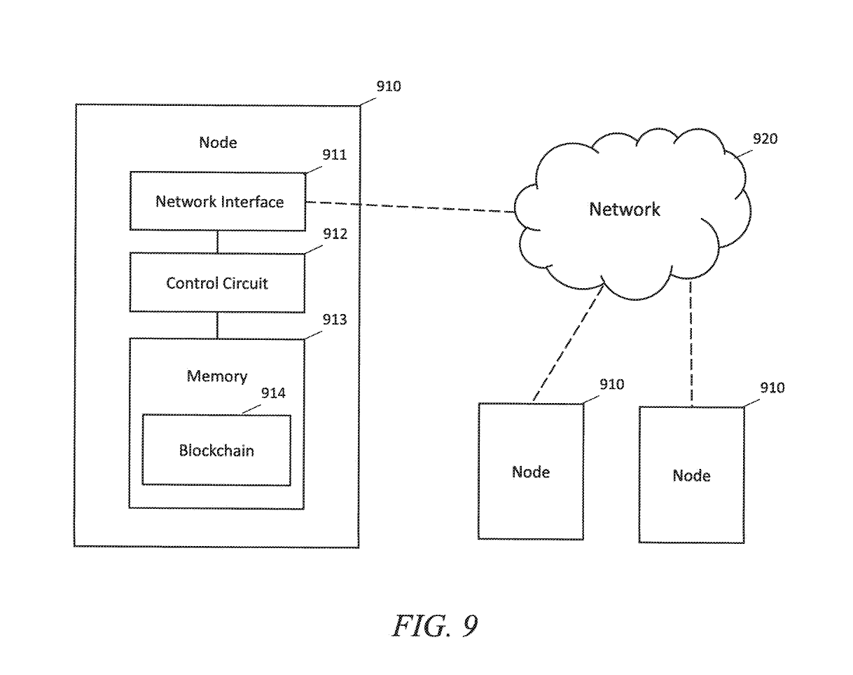

Now referring to FIG. 9, a system according to some embodiments is shown. A distributed blockchain system comprises a plurality of nodes 910 communicating over a network 920. In some embodiments, the nodes 910 may be comprise a distributed blockchain server and/or a distributed timestamp server. In some embodiments, one or more nodes 910 may comprise or be similar to a “miner” device on the Bitcoin network. Each node 910 in the system comprises a network interface 911, a control circuit 912, and a memory 913. In other examples, the nodes 910 may be an aerial drone or a transmission station.

The control circuit 912 may comprise a processor, a microprocessor, and the like and may be configured to execute computer readable instructions stored on a computer readable storage memory 913. The computer readable storage memory may comprise volatile and/or non-volatile memory and have stored upon it a set of computer readable instructions which, when executed by the control circuit 912, causes the node 910 update the blockchain 914 stored in the memory 913 based on communications with other nodes 910 over the network 920. In some embodiments, the control circuit 912 may further be configured to extend the blockchain 914 by processing updates to form new blocks for the blockchain 914. Generally, each node may store a version of the blockchain 914, and together, may form a distributed database. In some embodiments, each node 910 may be configured to perform one or more steps described with reference to FIGS. 6-7 herein.

The network interface 911 may comprise one or more network devices configured to allow the control circuit to receive and transmit information via the network 920. In some embodiments, the network interface 911 may comprise one or more of a network adapter, a modem, a router, a data port, a transceiver, and the like. The network 920 may comprise a communication network configured to allow one or more nodes 910 to exchange data. In some embodiments, the network 920 may comprise one or more of the Internet, a local area network, a private network, a virtual private network, a home network, a wired network, a wireless network, and the like. The network 920 may be over the air, over wires, or over fiber optic cables to mention a few examples. In some embodiments, the system does not include a central server and/or a trusted third-party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system that is configured to allow an aerial drone to autonomously determine a current location of the aerial drone using electromagnetic energy signals from transmitting stations, the system:
a plurality of transmission stations, each of the transmission stations configured to transmit electromagnetic energy signals, each of the electromagnetic energy signals communicating data;
an aerial drone, the aerial drone including a transceiver circuit, a control circuit, and a memory device;
wherein the transceiver circuit is configured to receive at least some of the electromagnetic energy signals;
wherein the memory device is configured to store a ledger of acceptable identification information;
wherein the control circuit is configured to:
perform a comparison of identification information inherent to or transmitted with the electromagnetic energy signals to the acceptable identification information in the ledger, and when the comparison identifies a valid transmission station, allow the processing of the electromagnetic energy signals from the valid transmission station, the processing being effective to ascertain the location of or fine-tune the location of the aerial drone;
when the comparison identifies an invalid transmission station, ignore signals transmitted from the invalid transmission station;
operate the aerial drone according to the modified location.

2. The system of claim 1, wherein the ledger is a blockchain that stores transactions.

3. The system of claim 1, wherein the electromagnetic energy signals are light signals.

4. The system of claim 1, wherein the acceptable identification information includes acceptable keys, geographic coordinates, codes, identifiers, store number, or patterns.

5. The system of claim 1, wherein the location is ascertained through triangulation or landmark recognition approaches.

6. The system of claim 1, wherein the aerial drone communicates with the transmission stations using second electromagnetic energy signals.

7. The system of claim 1, wherein the transmission station is at a fixed location on the ground or is a mobile electronics device.

8. The system of claim 1, wherein the transmission station is a second aerial drone.

9. The system of claim 1, wherein data is embedded or encoded into the electromagnetic energy signals.

10. The system of claim 1, wherein the electromagnetic energy signals are pulsed according to varied wavelengths to convey the data.

11. A method of determining the current location of an aerial drone using electromagnetic energy signals from light transmitting stations, the system comprising:
transmitting electromagnetic energy signals from a plurality of transmission stations, each of the signals communicating data;
receiving the signals at an aerial drone, the aerial drone including a transceiver circuit, a control circuit, and a memory device, wherein the transceiver circuit is configured to receive at least some of the signals;
storing a ledger of acceptable identification information in the memory device at the aerial drone;
at the control circuit of each aerial drone, performing a comparison of identification information inherent to or transmitted with the electromagnetic energy signals to the acceptable identification information in the ledger and when the comparison identifies a valid transmission station, allow the processing of the electromagnetic energy signals from the valid transmission station, the processing being effective to ascertain the location of or fine-tune the location of the aerial drone;
at the control circuit, when the comparison identifies an invalid transmission station, ignoring the signals transmitted from the invalid transmission station, and operating the aerial drone according to the modified location.

12. The method of claim 11, wherein the ledger is a blockchain that stores transactions.

13. The method of claim 11, wherein the electromagnetic energy signals are light signals.

14. The method of claim 11, wherein the acceptable identification information includes acceptable keys, geographic coordinates, codes, identifiers, store number, or patterns.

15. The method of claim 11, wherein the location is ascertained through triangulation or landmark recognition approaches.

16. The method of claim 11, wherein the aerial drone communicates with the transmission stations using second electromagnetic energy signals.

17. The method of claim 11, wherein the transmission station is at a fixed location on the ground or is a mobile electronics device.

18. The method of claim 11, wherein the transmission station is a second aerial drone.

19. The method of claim 11, wherein data is embedded or encoded into the electromagnetic energy signals.

20. The method of claim 11, wherein the electromagnetic energy signals are pulsed according to varied wavelengths to convey the data.
